(19) United States
(12) Patent Application Publication
(10) Pub. No.: US 2026/0251249 A1
(43) Pub. Date: Aug. 27, 2026

(54) ASSEMBLY RING AND PIPE CONNECTION SYSTEM

(71) Applicant: NORMA GERMANY GMBH, Maintal (DE)

(72) Inventors: Belal AKREMI, Newbury, Berkshire (GB); Mateusz JAROSZ, Newbury, Berkshire (GB); Tatjana RUMBAUSKIENE, Newbury, Berkshire (GB); Gerrit VON BREITENBACH, Maintal (DE); Febin MATHEW, Newbury, Berkshire (GB); Andon NIKOLOV, Newbury, Berkshire (GB)

(21) Appl. No.: 18/870,732

(22) PCT Filed: May 25, 2023
(86) PCT No.: PCT/EP2023/064008

§ 371 Date: Dec. 2, 2024

(30) Foreign Application Priority Data
Jun. 1, 2022 (DE) 10 2022 113 803.8

(51) Int. Cl. F16L 23/18; F16L 23/00; F16L 23/04

(52) U.S. Cl. CPC F16L 23/18; F16L 23/003; F16L 23/04

(57) ABSTRACT

An assembly ring for a pipe connection system is described. The assembly ring has a supporting ring and a functional ring. The supporting ring has at least one holding element for the functional ring and the functional ring is mounted rotatably in the holding element.

### INTRODUCTION

The disclosure relates to an assembly ring and to a pipe connection system.

Pipes are often connected to each other using pipe clamps. For example, it needs to be ensured that the pipe ends which are connected to each other butt tightly against each other so that material transported through the pipes, in particular liquid, cannot escape at the connection point. It is therefore customary to arrange a corresponding assembly element between the two pipe ends to be connected. This assembly element is usually annular and, inter alia, can take over the function of a seal.

A frequent problem is that a plurality of components have to be handled simultaneously during the assembly, namely the two pipe ends, the pipe clamp and the seal. In particular when the pipe clamp is not yet tightened but, for example, the tool for doing this is already to be positioned with one hand, there is a risk that the remaining parts that have previously been brought into position will slip apart or drop down again because it may be difficult to hold all of them simultaneously with the other hand. This is time-consuming and nerve-racking and may cause the assembly operation to have to be restarted. It may also happen that, although the seal does not drop down, it slips unnoticed during the assembly. As a result, the pipe ends which are connected to each other may be only insufficiently sealed against each other. This problem also occurs if, for example, strainer elements, sensors or similar components are to be mounted at the connection point.

EP 2 598 785 B1 discloses, for example, a clamping system for connecting a first and a second pipe. The clamping system has a clamp and plain washer, wherein the plain washer is fixedly connected to the clamp. The plain washer is used here as a sealing element.

The fixed connection of the plain washer, which is used as a seal, to the clamp may firstly be a problem here. It is thereby not possible, or possible only to a very limited extent, to manufacture the clamp and the plain washer from different materials. However, it is precisely this which is often desired. For example, if the seal is to be made of a soft and plastically deformable material, but the clamp is to be as strong and dimensionally stable as possible. If the two parts are fixedly connected to each other, different materials with different coefficients of thermal expansion may lead to high stresses between the components and ultimately to undesirable leakages. In this respect, it is then more advantageous to configure the seal and the clamp from different materials and as separate components. However, this is contrary to the problem described above of the difficult and possibly awkward and error-prone assembly.

### SUMMARY

It is therefore an object per an embodiment to provide an improved assembly ring that can be used in a pipe connection system. The assembly is intended to be as simple and error-free as possible. At the same time, it is also intended to be possible, for example, to manufacture a seal installed with the assembly ring from a different material from the connecting clamp and/or to be able to mount further components, such as strainer elements, sensors or the like at the connection point quickly, simply and reliably.

In the case of an assembly ring for a pipe connection system, wherein the assembly ring has a supporting ring and a functional ring, the supporting ring has at least one holding element for the functional ring and that the functional ring is mounted rotatably in the holding element, per an embodiment.

In this context, an assembly ring is a device that can be used in the connection of two pipes to prevent a material that is transported through the pipes from being able to escape at the connection point and/or to be able to mount further components, such as strainer elements, sensors or the like at the connection point inside the pipes. In this respect, the assembly ring can be a sealing element. The connection of the pipes is preferably, per an embodiment, a connection in which the pipes are connected via a clamp, particularly preferably via a V-profile clamp. It is conceivable that the pipes have rectilinear or flange-shaped end pieces that are connected to each other. However, the assembly ring, per an embodiment, can be particularly advantageously used when two pipes are connected to each other, where the first pipe has a funnel-shaped end piece and the second pipe has a biconical end piece, which is inserted into the funnel-shaped end piece.

A pipe connection system is a set of components that can be used to connect two pipes to each other. The assembly ring is one of the components from this set.

The supporting ring supports the functional ring. The supporting ring of the assembly ring is designed in such a way that it can be fixed in a component, preferably in a V-profile clamp per an embodiment, which is used for connecting the two pipe ends. The other component is preferably also part of the pipe connection system, per an embodiment. For example, the supporting ring can be produced as a punched-bent part, i.e. it is punched out of a material and then bent into shape. For example, the supporting ring can be punched out of a metal sheet and the holding element can then simply be bent inward. The supporting ring can have a flat basic shape or a conical basic shape. If it has a flat shape, it can also be considered to be a circular disk. The shape of the assembly ring corresponds to the shape of the supporting ring.

If the assembly ring is conical, it is not restricted to a certain angle, but as steep or flat positions of the cone sides as desired, depending on the area of application, are conceivable.

The functional ring is designed as a separate component and is held on the supporting ring via the holding element. The functional ring is arranged between the two pipe ends in the mounted state. It can form the seal. It is also conceivable that the functional ring supports other components, such as sensors, strainer elements or the like. The other components can protrude from the functional ring into the space between the pipes.

In a first embodiment, both the supporting ring and the functional ring substantially have the shape of an annular disk, with a substantially circular outer circumference, an annular portion and a central, likewise substantially circular recess. If the functional ring assumes the function of a seal, it is also conceivable that it is designed at least in certain sections as a volume seal.

The holding element is part of the supporting ring. For example, it can be hook-shaped or rail-shaped. Preferably, per an embodiment, it is formed in such a way that a gap or a break, in which the functional ring can be inserted, is formed between the holding element and the annular portion of the supporting ring. The holding element may be formed integrally with the supporting ring. It is also conceivable that it is mounted on the supporting ring in a form-fitting, force-fitting or integrally bonded manner, for example by being soldered on, clipped on, crimped or the like.

It is particularly advantageous, per an embodiment, that the functional ring is held on the supporting ring rotatably, i.e. movably. A rotatable mounting is understood to mean here that the functional ring is held captively on the supporting ring. The two components therefore cannot come apart by themselves. At the same time, the two components butt against each other in such a way that their respective circle center points lie substantially one above the other and the annular disks are substantially arranged in parallel planes to each other. An imaginary axis is therefore possible that passes through the center points of the supporting ring and the functional ring and about which the two components can be rotated. The supporting ring and the functional ring can rotate independently of each other and in the same or opposite direction. In other words, the supporting ring and the functional ring lie parallel to each other and can be twisted in relation to each other. The functional ring has a little play in the unmounted state and is nevertheless held captively in the assembly ring. By way of the available movement possibility, the assembly ring can easily fit into the desired position, and is, for example, finally secured only by tightening of the V-profile clamp and can then carry out a sealing function. At the same time, the supporting ring and the functional ring can be mounted and aligned together during the assembly. There is no need to guide and to handle a plurality of components in the hand.

In a simple form, the assembly ring can have the shape of a flat disk. Alternatively, the assembly ring may also have a conical shape which is adapted to the conical shape of a biconical end of a pipe or to a corresponding shape of a funnel-shaped end of a pipe to be connected to the biconical end of the first pipe. If the assembly ring has such a shape, at least the supporting ring has a corresponding conical shape. Preferably, in this case and per an embodiment, the functional ring also has a corresponding conical basic shape. However, it is also conceivable that the functional ring is made of a correspondingly elastic material, which simply adapts to the basic shape of the supporting ring.

A particular advantage, per an embodiment, is also that the functional ring can be composed of a different material from the supporting ring. In this way, the materials of the two components can be optimally matched independently of each other to the respective tasks that the two components are intended to be used for. For example, rubber-coated metal seals that are used in the region of cooling systems for batteries or stationary energy storage systems, multi-layer seals that are composed of different material combinations and density layers, such as combinations of metal and mica or combinations of metal and graphite; generally graphite seals or, for example, seals made of cork or the like, are conceivable. It is also conceivable that the supporting ring is manufactured from a more dimensionally stable material than the functional ring. This allows the functional ring to readily adapt to the gap between the two pipes to be connected, while the stable supporting ring at the same time ensures that the assembly ring remains in the correct place and does not slip. Preferably, in this respect and per an embodiment, the functional ring is composed of a softer material than the supporting ring. It is also conceivable that the functional ring is made of a particularly heat-resistant material. It is seen that it is also advantageous, per an embodiment, with regard to the different coefficients of thermal expansion when using different materials for the functional ring and the supporting ring if the functional ring and the supporting ring are not fixedly connected to each other, but the functional ring is held movably on the supporting ring. In principle, in this respect, a wide variety of materials and shapes are conceivable for the design of a corresponding seal.

In an embodiment variant, the at least one holding element has a U-shaped profile. Such a U-profile is particularly advantageous, per an embodiment, to enable the rotatable mounting of the functional ring. A corresponding profile can also be C-shaped or V-shaped; it is suitable per an embodiment that it is a profile with an upper leg that is part of the supporting ring and with a lower leg on which the functional ring rests. The lower leg is formed by the annular portion of the supporting ring. The upper leg is positioned around the outer edge of the functional ring in the mounted state. It is particularly advantageous, per an embodiment, in this case if the functional ring is inserted into the U-shaped profile of the at least one holding element in the mounted state in such a way that a break is formed between the free U-leg and the functional ring. In the simplest case, it is conceivable that the supporting ring is formed as a punched part from a metal sheet, wherein the holding element initially extends outward as a strip-shaped extension from the outer circumference of the ring, i.e. away from the ring center, and is bent back during the production of the supporting ring in the direction of the ring center. The width and length of the strip-shaped extension and thus the width and length of the holding element can vary. The width is understood as meaning the extent along the circumference of the annular portion, while the length is understood as meaning the extent in the radial direction relative to the radius of the annular portion. In this respect, the holding element can be considered to be hook-shaped with a narrow width. For a larger width, it can also be considered to be rail-shaped.

It is seen that it is advantageous, per an embodiment, if at least two holding elements are provided. For example, two diametrically opposed holding elements can be provided. However, it is particularly advantageous, per an embodiment, if a plurality of holding elements are uniformly distributed over the circumference of the supporting ring. In particular if hook-shaped holding elements are involved, it is seen that they can be manufactured in a manner saving more on material and more simply than fully or partially circumferential holding rails.

In other words: the holding element can be hook-like or rail-like. The holding element can extend along a portion of the circumference of the supporting ring. A plurality of holding elements can be formed at different points of the circumference of the supporting ring. The holding elements can be arranged in pairs opposite each other. The holding elements can be arranged in such a way that they form a polygon. It is particularly advantageous, per an embodiment, if the sides of the polygon are equal in length. The force distribution of the holding force is then uniformly distributed over the circumference of the supporting ring and the functional ring. In any case, it is advantageous, per an embodiment, if the holding elements are arranged on the circumferential side of the supporting ring.

In another embodiment variant, the functional ring has a holding collar and a sealing portion. The holding collar per an embodiment is preferably flat and parallel to the surface of the annular portion of the supporting ring. The holding collar is the part of the functional ring that engages in the holding element. A break is preferably formed, per an embodiment, between the holding collar and the upper leg of the holding element. This assists the movability of the functional ring in this holder formed in this way. The holding collar and the sealing portion are in each case formed integrally and differ only in their shape. While the holding collar, as described above, is flat and parallel to the surface of the annular portion of the supporting ring, the sealing portion is preferably curved, per an embodiment. This affords the advantage, per this embodiment, that the holding collar can retain its shape when pressure is exerted on the curved sealing portion during the assembly and the tightening of the V-profile clamp. This can reduce the risk of the functional ring slipping out of the supporting ring due to deformation caused by the action of force when tightening the profile clamp. At the same time, however, it is possible to produce an optimal seal, which could not be achieved with a non-curved assembly ring or could only be achieved with much greater action of force. It is seen in this respect that it is advantageous, per an embodiment, if the holding collar lies in the holding elements. Furthermore, it is advantageous, per an embodiment, if the sealing portion is formed resiliently and/or if the sealing portion has a curved shape.

In yet another embodiment, the functional ring has a support portion. The support portion can be formed, for example, as an extension of the sealing portion arranged toward the center of the circle. Like the holding collar, the support portion is also flat. If the assembly ring is used to connect a funnel-shaped end of a first pipe and a biconical end of a second pipe, the support portion in the mounted state can fit against the outer wall of the biconical end of the one pipe, while the sealing portion at the same time presses with its bulge against the inner wall of the funnel-shaped end of the other pipe. In this way, a good and stable seal can be achieved.

Regardless of the configuration of the functional ring, it is advantageous per an embodiment if the supporting ring has at least one clamping element. The clamping element can be used to pre-assemble the assembly ring in the V-profile clamp. In this way, the assembly ring can initially be fastened loosely but captively in the V-profile clamp. During the assembly, the V-profile clamp and the assembly ring can then be attached simultaneously and as one component to the first of the two pipes to be connected. It is advantageous per an embodiment if at least four clamping elements are formed. Three or more than four clamping elements are also conceivable. The clamping elements are preferably arranged uniformly along the circumference of the supporting ring, per an embodiment. The clamping elements are configured in such a way that the assembly ring can be secured on the V-profile clamp using the clamping elements. Preferably, per an embodiment the clamping element has two clamping wings for the circumferential clamping. The clamping wings are arranged in a V shape. The clamping element also has an elbow which assists the lateral support.

Furthermore, it is advantageous per an embodiment if the supporting ring has at least one first assembly element for fixing to a first pipe. This allows the assembly ring to be pre-assembled on one of the two pipes to be connected. The supporting ring can be used to pre-assemble the assembly ring in a V-profile clamp. For example, the assembly ring can simply be clipped onto the end of the first pipe. More specifically: the supporting ring can be clipped onto the pipe end. As a result, the entire assembly ring and also the pipe connection system, which consists of the profile clamp and assembly ring, can be clipped onto the pipe end. This can be undertaken in the case of small pipes with two or three fingers of one hand, while holding the pipe between the ring finger, small finger and palm of the hand, for example. This type of pre-assembly of the assembly ring is of course possible even for larger pipes. It is also conceivable that the assembly ring can thereby be pre-assembled and pre-positioned at the first pipe end. As a result, one-handed assembly of the two pipes is then possible. It is seen that it is advantageous, per an embodiment, if the assembly element is, for example, a clip element or a spring element. In addition, it is advantageous per an embodiment if the supporting ring has at least one second assembly element for fixing to a second pipe. The second pipe can likewise be simply clipped on with the aid of the second assembly element. The two assembly elements then hold the supporting ring and thus the assembly ring in place between the pipes to be connected, even if the V-profile clamp has not yet been tightened. When the V-profile clamp is subsequently tightened, the assembly ring can then align itself when the V-profile clamp is tightened and finds the optimum position so that it subsequently fits truly tightly. It is seen that it is advantageous per an embodiment if at least two first assembly elements and two second assembly elements are formed. The assembly elements may extend along a portion of the circumference of the supporting ring. A plurality of assembly elements may be formed at different points of the circumference of the supporting ring. The assembly elements can be arranged in pairs opposite each other. For example, the assembly elements may be arranged such that they form a polygon, wherein the sides of the polygon are preferably equal in length, per an embodiment. The distribution of the holding force is then uniformly distributed over the circumference.

In one embodiment variant, it is provided, for example, that the holding elements, assembly elements and/or clamping elements are each formed in pairs at diametrically opposite positions along the circumference of the supporting ring. Such a symmetrical alignment results in a uniform distribution of force, pressure and weight across the entire circumference of the assembly ring. An arrangement of the holding, clamping and assembly elements extending in four main directions from the supporting ring is also advantageous, per an embodiment: if the supporting ring is conceived as a circular disk, a circular plane can be defined in which said circular disk is located. The circular disk has an outer circumference. From this plane and from the circumference, it is possible in each case to define two different directions: from the plane upward and from the plane downward, from the circumference outward, and from the circumference inward toward the center point of the circle. The main directions of the respective elements can then extend as follows: the holding elements are preferably, per an embodiment, oriented inward from the circumference, with the open profile side in this direction. The clamping elements are preferably oriented outward from the circumference, per an embodiment. The assembly elements are aligned from the plane downward or upward, with similar assembly elements each being aligned in the same direction. The angle at which the elements extend in the respective direction can be variable and adapted to the specific embodiment in each case. In yet another embodiment variant, it is conceivable that the at least one clamping element simultaneously forms the at least one holding element. Such a clamping element may be referred to as a combined clamping and holding element. A corresponding supporting ring can then, for example, have at least one, preferably more than a combined clamping and holding element and at least one first and at least one second assembly element.

In every case, per an embodiment, it is conceivable that the functional ring is a sealing element, as already mentioned above. The sealing element can be composed of different materials and/or material combinations. For example, rubber-coated metal seals, cork seals, graphite seals or multi-layer seals made of a composite of metal and mica or also of metal and graphite are conceivable. It goes without saying that this list serves only for explanation and that a multiplicity of other materials and material combinations are possible. The assembly ring is also suitable to this extent for a variety of different applications.

In one embodiment variant, it is conceivable that the functional ring has at least one, preferably two radially inwardly projecting, elastically deformable fingers. During the positioning of the assembly ring, these fingers can be used to preload a flange to which the assembly ring is to be fastened. Such a preload can facilitate the one-handed assembly.

In another embodiment variant, it is conceivable that at least one of the aforementioned elements arranged on the supporting ring, i.e. one of the holding elements, a clamping element, a combined clamping and holding element, a first assembly element and/or a second assembly element, forms a pin element for a pre-positioning device. Alternatively, such a pin element can also be designed as an additional element on the supporting ring. In every case, per an embodiment, such a pin element is designed such that it can engage in a groove, which is formed, for example, on a flange of a pipe section, on which the assembly ring is to be mounted.

In a further aspect, per an embodiment, a pipe connection system is provided for connecting a first pipe and a second pipe, wherein the pipe connection system comprises a V-profile clamp and an above-described assembly ring, wherein the first pipe has a funnel-shaped end and the second pipe has a biconical end, and wherein the functional ring of the assembly ring in the mounted state is arranged between the inside of the funnel-shaped end of the first pipe and the outside of the biconical end of the second pipe, and wherein the supporting ring in the mounted state is arranged between the first pipe, the second pipe and the V-profile clamp. It goes without saying that what has been stated above with regard to the assembly ring and its configuration also fully applies to the assembly ring mentioned here of the pipe system. In this respect, reference is made to what has been stated above with regard to the configuration of the assembly ring. Such a pipe connection system affords numerous advantages, per various embodiments. In particular, the assembly ring fits optimally between the two pipe ends during the assembly. Owing to the clamping and assembly elements, it can be pre-positioned together with the V-profile clamp on a pipe end. The second pipe end can then be inserted very simply. The assembled pipe ends can be held with one hand without the risk of the parts coming apart or the seal slipping.

In one embodiment variant, it is provided that a pre-positioning device is formed between at least one pipe and the supporting ring of the assembly ring, wherein the pre-positioning has a pin element formed on the supporting ring and a groove formed on the first pipe or on the second pipe. The groove, per an embodiment, is preferably formed in the region of the respective pipe end. During the assembly, the pin element of the assembly ring can engage in the groove. This can simplify the alignment of the assembly ring at the pipe end. In particular, the assembly ring can undergo a certain locking in the correct position.

It is also conceivable, per an embodiment, that the pin element of the pre-positioning device is formed by the at least one holding element, the at least one first or second assembly element or the at least one clamping element of the supporting ring or as part of the at least one holding element, as part of the at least one first or second assembly element or as part of the at least one clamping element of the supporting ring.

### BRIEF DESCRIPTION OF THE FIGURES

Further features, details and advantages of the disclosure emerge from the wording of the claims and from the description below of exemplary embodiments with reference to the drawings, in which:

FIG. 1 shows a schematic cross section through a first variant of an assembly ring;

FIG. 2 shows a schematic cross section through a second variant of an assembly ring;

FIG. 3a shows a schematic top view of a supporting ring of an assembly ring;

FIG. 3b shows a schematic cross section through a clamping element along the intersecting plane of A-A of FIG. 3a;

FIG. 3c shows a schematic top view of the clamping element of FIG. 3b;

FIG. 3d shows a schematic cross section through a first assembly element along the intersecting plane B-B of FIG. 3a;

FIG. 3e shows a schematic top view of the assembly element of FIG. 3d;

FIG. 3f shows a schematic cross section through a second assembly element along the intersecting plane C-C of FIG. 3a;

FIG. 3g shows a schematic top view of the assembly element of FIG. 3f;

FIGS. 4a and 4b show a schematic illustration of the spatial directions of extent of the holding, clamping and assembly elements of the assembly ring;

FIG. 5 shows a schematic cross section through an assembled pipe connection system with assembly ring;

FIG. 6 shows a schematic cross section through a further variant of an assembly ring;

FIG. 7 shows a schematic top view of a variant of a functional ring of the assembly ring;

FIG. 8a shows a perspective view of a further variant of an assembly ring;

FIGS. 8 b and 8 c show a cutout of a 3D view, in which an assembly ring is mounted between two pipe ends and in which a pin element and a groove serve as a pre-positioning device;

FIG. 9 shows a cutout of a 3D view of the variant of the assembly ring shown in FIG. 6.

### DETAILED DESCRIPTION

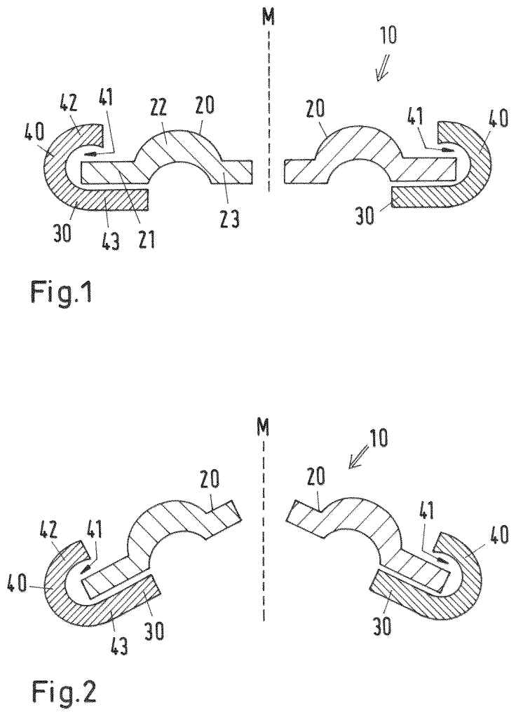

FIGS. 1 and 2 show a cross section through an assembly ring 10. The cross section runs along the center axis M, which constitutes the center axis of the assembly ring 10, about which the assembly ring 10 is rotatable. The assembly ring 10 has a supporting ring 30 and a functional ring 20. Holding elements 40 are formed on the supporting ring 30. The holding elements 40 have a U-shaped profile with an upper leg 42 and a lower leg 43. The lower leg 43 is a part of the supporting ring 30.

The functional ring 20 has a holding collar 21, a sealing portion 22 and a support portion 23. The sealing portion 22 has a curved shape. The holding collar 21 rests on the lower leg 43 of the holding element 40 and thus on the supporting ring 30. The holding collar 21 is surrounded by the upper leg 42 of the holding element 40. A clearance 41 is formed between the holding collar 21 and the upper leg 42 of the holding element. By holding the functional ring 20 on the supporting ring 40 in this way with the aid of the holding elements 40, the functional ring 20 is mounted rotatably on the supporting ring 20.

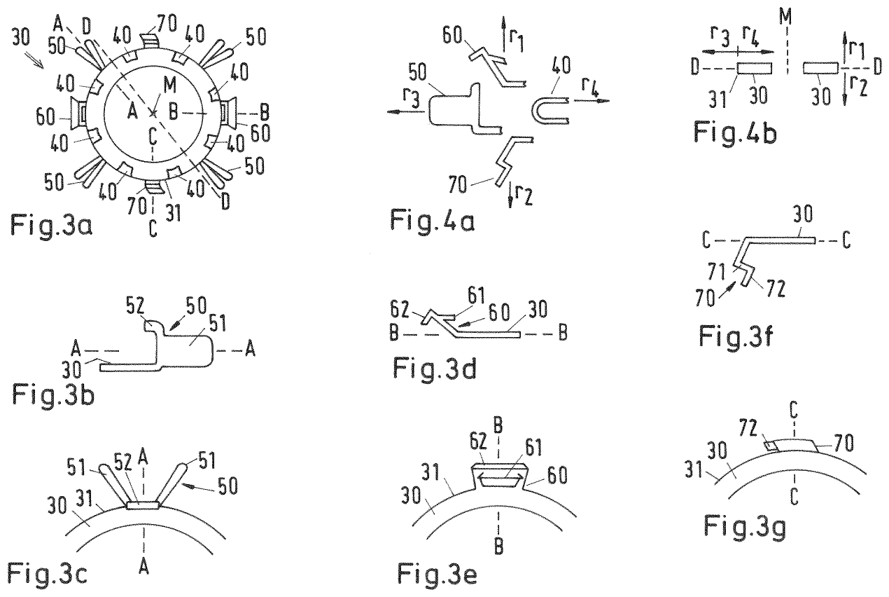

In FIG. 1, the assembly ring 10 and thus the supporting ring 30 and the functional ring 20 have a flat basic shape. That is to say, the supporting ring 30 substantially has the shape of a circular disk, from which the holding elements 40 and optionally present assembly and clamping elements, not illustrated here, can extend in the different spatial directions, as described in conjunction with FIGS. 3a to 5h.

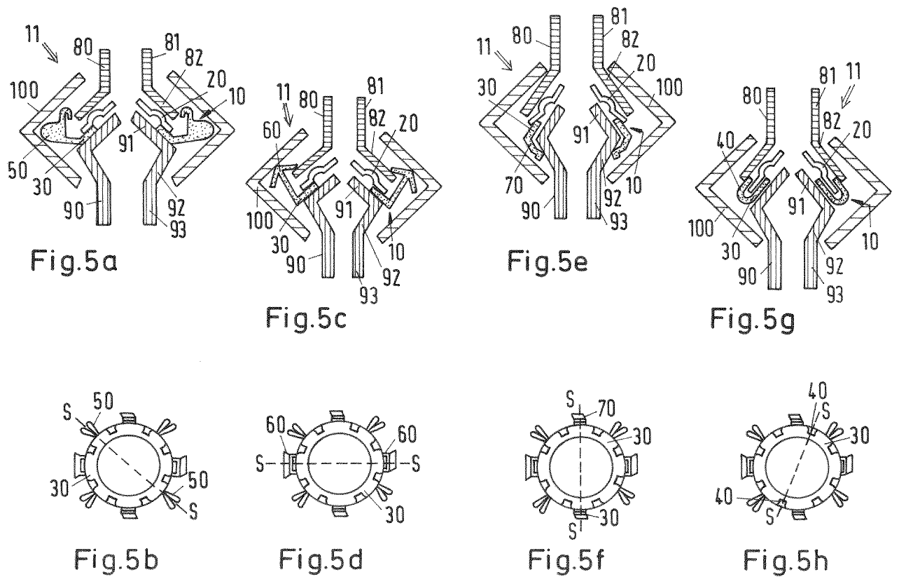

In FIG. 2, the assembly ring 10 has a slightly conical basic shape. It can thus readily fit at the end of a biconical pipe section, as can be seen in FIGS. 5a to 5h. The angle at which the walls of the cone are positioned is conceivably as large or small as desired and is in no way limited to the position shown by way of example of approximately 45°.

FIG. 3a shows a schematic top view of a supporting ring 30 of an assembly ring 10. FIGS. 3b to 3g show detailed views of the supporting ring 30 illustrated in FIG. 3 a. Such a supporting ring 30 can be used for all assembly rings described above and below.

The supporting ring 30 has a circular disk-shaped basic shape. It can be both flat and slightly conical. The supporting ring 30 has an outer circumference. A plurality of holding elements 40, clamping elements 50, first assembly elements 60 and second assembly elements 70 are formed on said outer circumference 31.

The holding elements 40, clamping elements 50, first assembly elements 60 and second assembly elements 70 extend from the supporting ring 30 in different spatial directions. In FIG. 4b, it is seen that there are four directions with respect to the supporting ring 30, which are of particular interest in this context. FIG. 4b shows a section along the line D-D of FIG. 3a. A first direction r₁ extends upward from the plane in which the circular disk of the supporting ring 30 extends. A second direction r₂ extends downward from this plane. A third direction r₃ extends outward from the circumference 31 of the supporting ring 30. A fourth direction r₄ extends from the circumference 31 of the supporting ring 30 to the center point M of the supporting ring 30.

FIG. 4a schematically illustrates an arrangement of the different holding elements 40, clamping elements 50, first and second assembly elements 60, 70 in these four spatial directions. It is seen that the four different elements 40, 50, 60, 70 extend in in each case different spatial directions r₁, r₂, r₃, r₄. The holding elements 40 extend in the direction r₄. The clamping elements 50 extend in an opposed manner to the holding elements 40 in the direction r₃. The first assembly elements 60 extend in the direction r₁. The second assembly elements 70 extend in an opposed manner to the first assembly elements 60 in the direction r₂. In the mounted state, the first and second assembly elements 60, 70 then extend substantially in the direction of the longitudinal axes of the two pipes to be connected, at least in the connection region. The holding and clamping elements 40, 50 extend more or less perpendicularly thereto, as can also be seen in FIGS. 5a to 5h.

FIGS. 3b and 3c show a section along the line A-A of FIG. 3a. A clamping element 50 is arranged on the supporting ring 30 in this region. The clamping element 50 has two clamping wings 51 and a clamping elbow 52. The clamping element 50 extends substantially in the direction r3 from the circumference 31 of the supporting ring 30 outward.

FIGS. 3d and 3e show a section along the line B-B of FIG. 3a. A first assembly element 60 is arranged on the supporting ring 30 in this region. The assembly element 60 has two clamping spring elements 61, 62. With said two clamping spring elements 61, 62, the assembly element 60 can be clipped to a first pipe end.

FIGS. 3f and 3g show a section along the line C-C of FIG. 3a. A second assembly element 70 is arranged on the supporting ring 30 in this region. The assembly element 70 has two clamping spring elements 71, 72. With said two clamping spring elements 71, 72, the assembly element 70 can be clipped to a second pipe end.

FIGS. 5a, 5c, 5e and 5g each show a cross section through an assembled pipe connection system 11. For better orientation, FIGS. 5b, 5d, 5f and 5h additionally show in which plane the intersecting plane S-S runs through the supporting ring 30, which is mounted in the pipe connection system 11, of the assembly ring 10. FIG. 5d shows the intersecting plane S-S in which the view in FIG. 5a is sectioned. FIG. 5f shows the intersecting plane S-S in which the view in FIG. 5c is sectioned. FIG. 5h shows the intersecting plane S-S in which the view in FIG. 5e is sectioned. FIG. 5g shows the intersecting plane S-S in which the view in FIG. 5h is sectioned.

FIGS. 5a, 5c, 5e and 5g each show a first pipe 80 and a second pipe 90. The first pipe 80 has a cylindrical pipe section 81 and a funnel-shaped pipe section 82. The second pipe 90 has a cylindrical pipe section 93, a first conical pipe section 92, and a second conical pipe section 91. The second pipe 90 to this extent has a biconical pipe end. The biconical pipe end is initially further in the region of the first conical pipe section 92 than the cylindrical pipe section 93. In the region of the second conical pipe section 91, the biconical pipe end is narrowed again. The funnel-shaped pipe section 82 of the first pipe 80 is continuously further in the direction toward the second pipe 90 than the cylindrical pipe section 81. The funnel-shaped pipe section 82 of the first pipe 80 is designed in such a way that the second conical pipe section 91 can be inserted into the funnel-shaped pipe section 82. The inner shape of the funnel-shaped pipe section 82 substantially corresponds to the outer shape of the second conical pipe section 91.

The assembly ring 10 with its supporting ring 30 and the functional ring 20 is arranged between the funnel-shaped pipe section 82 and the second conical pipe section 91. A V-profile clamp 100 surrounds the connection region and butts both against the outside of the first pipe 80 and against the outside of the second pipe 90.

In FIG. 5a, it is seen that the clamping elements 50 engage in the V-profile of the V-profile clamp 100. The clamping elements 50 thus fix the supporting ring 30 in the V-profile clamp 100.

In FIG. 5c, it is seen that the first assembly elements 60 fix the supporting ring 30 to the first pipe 80. The first assembly elements 60 firmly clamp the supporting ring 30 to the funnel-shaped pipe section 82. In FIG. 5e, it is seen that the second assembly elements 70 fix the supporting ring to the second pipe 90. The second assembly elements 70 firmly clamp the supporting ring 30 to the second conical pipe section 91 of the second pipe 90.

In FIG. 5g, it is seen that the holding elements 40 hold the functional ring 20, as already described with reference to FIGS. 1 and 2. It is seen that the illustrated exemplary embodiment of the pipe connection system 11 is an exemplary embodiment which uses an assembly ring 10 as illustrated in FIG. 2. Of course, it is also conceivable in further exemplary embodiments, as also described below, that an assembly ring 10 according to FIG. 1 is also used in a corresponding pipe connection system 11.

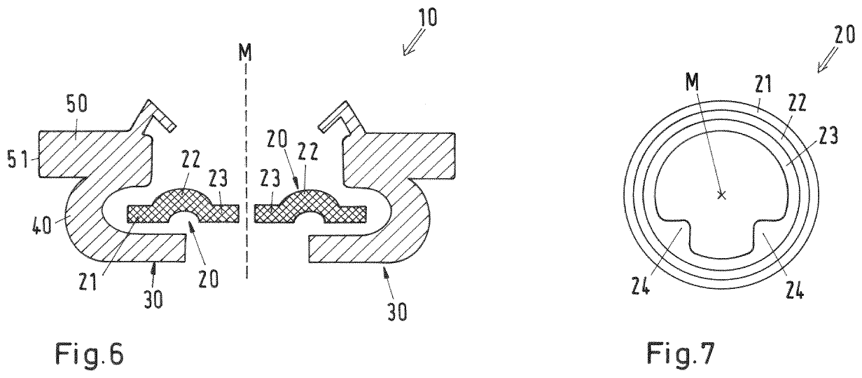

FIG. 6 shows a cross section through an assembly ring 10, as already illustrated in FIGS. 1 and 2. The cross section also runs here along the center axis M, which constitutes the center axis of the assembly ring, about which the ring is rotatable. Here, too, the assembly ring 10 has a supporting ring 30 and a functional ring 20. The holding elements 40 provided in this embodiment variant are combined with the clamping elements 50. A U-shaped profile can also be seen here. The upper leg 42 is formed by the clamping wings 51 of the clamping element 50. The lower leg 43 is also formed here as part of the supporting ring 30.

The functional ring 20 has a holding collar 21, a sealing portion 22 and a support portion 23. The sealing portion 22 has a curved shape. The holding collar 21 rests on the lower leg 43 of the holding element 40 and thus on the supporting ring 30. The holding collar 21 is surrounded by the upper leg 42 of the holding element 40.

FIG. 7 shows a top view of a functional ring 20 of an assembly ring 10 (not illustrated in FIG. 7). The functional ring 20 illustrated can be combined with each of the previously described variants of the supporting ring 30 to form an assembly ring 10. The viewing direction in the illustrated top view extends along the center axis M of the assembly ring 10. It is seen that the functional ring 20 has an outer portion, which forms the holding collar 21. In the mounted state, the holding collar 21 is held by the supporting ring 30, as shown above. The functional ring 20 furthermore comprises a sealing portion 22 and a support portion 23. In the exemplary embodiment according to FIG. 7, the functional ring 20 also has two fingers 24. Said fingers are oriented radially toward the center axis M.

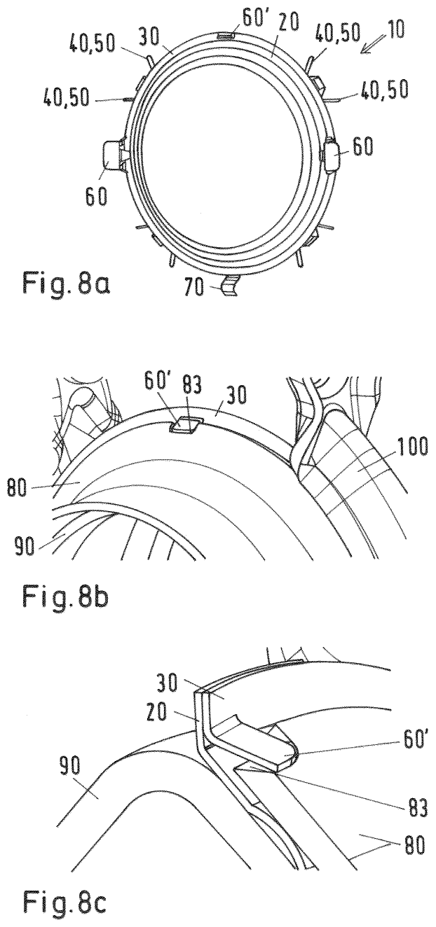

FIG. 8a shows an assembly ring 10, in which the supporting ring 30 has a pin element 60′. In this variant of the assembly ring 10, holding element 40 and clamping element 50 are formed by an element formed in each case jointly on the supporting ring 30. The supporting ring 30 also has first and second assembly elements 60, 70.

FIGS. 8b and 8c each show how a pin element 60′ formed on the supporting ring 30 engages in a groove 83. In the example shown, the groove 83 is formed on the first pipe 80. Of course, it can also be formed on the second pipe 90. FIG. 8a shows a top view of a corresponding pre-positioning device, while FIG. 8b illustrates the pre-positioning device in sectioned form.

It is conceivable here both that the pin element 60′ is formed as an independent element on the supporting ring 30 and that the pin element (not illustrated) is formed by the at least one holding element 40, the at least one first or second assembly element 60, 70 or the at least one clamping element 50 of the supporting ring 30 or as part of the at least one holding element 40, as part of the at least one first or second assembly element 60, 70 or as part of the at least one clamping element 50 of the supporting ring 30.

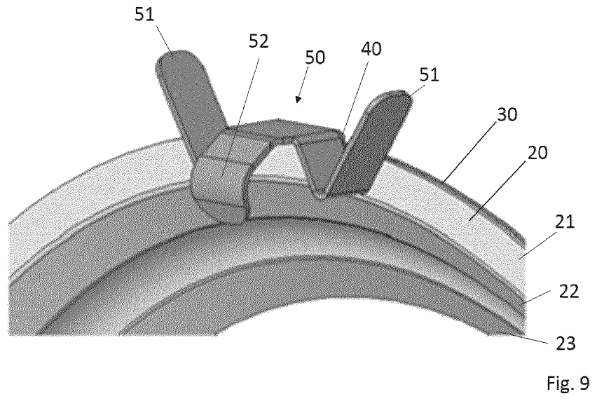

FIG. 9 shows in a perspective view how the clamping element 50 holds the functional ring 20 with the aid of the clamping wings 51. The clamping element 50 here also has two clamping wings 51 and a clamping elbow 52. It is formed integrally with the holding element 40, which, however, in the perspective view shown in FIG. 9, is almost completely covered by one of the clamping wings 51. The clamping element 50 is formed on the supporting ring 30. It is seen that the clamping wings 51 are V-shaped. Furthermore, it is seen that the clamping wings 51 hold the functional ring 20 on the supporting ring 30 in the region of the holding collar 21.

The invention is not restricted to one of the embodiments described above, but rather may be modified in a variety of ways.

For example, different further components can be arranged on the support portion 23 of the functional ring 20. For example, a strainer element is conceivable in one variant, and one or more sensors in another. It is also conceivable that the functional ring 20 has no sealing portion 22, but serves only to mount one or more further components in the region of the connection between the two pipes. The functional ring 20 can then, for example, consist entirely of the holding portion 21, with the further components being mounted on the holding portion 21. The other components here too may be sensors, strainer elements or the like.

It is also conceivable, for example, that both the first pipe 80 and the second pipe 90 have a flange-shaped end, in which a circular disk-shaped connection piece extends outward. The two pipes 80, 90 can then be aligned plane to each other during the connection to the flange ends, wherein the assembly ring 10 is formed corresponding to FIG. 1 and arranged between the two pipe ends. Also in this embodiment variant, the clamping elements 50 hold the supporting ring 30 in the V-profile clamp, while the holding elements 40 hold the functional ring 20 rotatably in the supporting ring 30. In this variant, the first and second assembly elements 60, 70 hold the supporting ring 30 and thus the assembly ring 10, for example, at the flange-shaped ends of the pipes 80, 90.

Thus, it is seen in each case that, in the case of an assembly ring 10 for a pipe connection system 11, wherein the assembly ring 10 has a supporting ring 30 and a functional ring 20, it is provided that the supporting ring 30 has at least one holding element 40 for the functional ring 20 and that the functional ring 20 is mounted rotatably in the holding element 40. It may be advantageous, per an embodiment, if the functional ring 20 is composed of a different material from the supporting ring 30. It is also conceivable that the at least one holding element 40 has a U-shaped profile. The functional ring 20 has a holding collar 21 and a sealing portion 22. Furthermore, the functional ring 20 can have a support portion 23.

It is advantageous, per an embodiment, if the supporting ring 30 has at least one clamping element 50. Furthermore, the supporting ring 30 can have at least one first assembly element 60 for fixing to a first pipe 80 and/or at least one second assembly element 70 for fixing to a second pipe 90. In this case, the holding elements 40, assembly elements 60, 70 and/or clamping elements 50 can each be formed in pairs at diametrically opposed positions along the circumference 31 of the supporting ring 30.

It is furthermore seen that it is advantageous, per an embodiment, in the case of a pipe connection system 11 for connecting a first pipe 80 and a second pipe 90, wherein the pipe connection system comprises a V-profile clamp 100 and an assembly ring 10, wherein the first pipe 80 has a funnel-shaped end and the second pipe 90 has a biconical end, if the functional ring 20 of the assembly ring 10 in the mounted state is arranged between the inside of the funnel-shaped end of the first pipe 80 and the outside of the biconical end of the second pipe 90, and wherein the supporting ring 30 in the mounted state is arranged between the first pipe 80, the second pipe 90 and the V-profile clamp 100.

All the features and advantages that emerge from the claims, from the description and from the drawing, including structural details, spatial arrangements and method steps, may be essential to the invention both individually and in a wide variety of combinations.

Furthermore, in general, while a multitude of embodiments have been depicted and described with a multitude of components in each embodiment, in alternative embodiments the components of various embodiments could be intermixed, combined, and/or exchanged for one another. In other words, components described in connection with a particular embodiment are not necessarily exclusive to that particular embodiment.

As used herein, the terms “general,” “generally,” and “approximately” are intended to account for the inherent degree of variance and imprecision that is often attributed to, and often accompanies, any design and manufacturing process, including engineering tolerances, and without deviation from the relevant functionality and intended outcome, such that mathematical precision and exactitude is not implied and, in some instances, is not possible.

All the features and advantages, including structural details, spatial arrangements and method steps, which follow from the claims, the description and the drawing can be fundamental to the invention both on their own and in different combinations. It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

### LIST OF REFERENCE NUMERALS

r₁ direction
r₂ direction
r₃ direction
r₄ direction
A-A intersecting plane
B-B intersecting plane
C-C intersecting plane
D-D intersecting plane
S-S intersecting plane
M center point
10 assembly ring
11 pipe connection system
100 V profile clamp
20 directional ring
21 holding collar
22 sealing portion
23 support portion
24 finger
30 supporting ring
31 outer circumference
40 holding element
41 clearance
42 upper leg
43 lower leg
50 clamping element
51 clamping wing
52 clamping elbow
60 assembly element
61 clamping spring element
62 clamping spring element
60′ pin element
70 assembly element
71 clamping spring element
72 clamping spring element
80 pipe
81 cylindrical pipe section
82 funnel-shaped pipe section
83 groove
90 pipe
91 conical pipe section
92 conical pipe section
93 cylindrical pipe section

1. An assembly ring for a pipe connection system, wherein the assembly ring has a supporting ring and a functional ring, wherein the supporting ring has at least one holding element for the functional ring and the functional ring is mounted rotatably in the holding element.

2. The assembly ring as claimed in claim 1, wherein the functional ring is composed of a different material from the supporting ring.

3. The assembly ring as claimed in claim 1, wherein the at least one holding element has a U-shaped profile.

4. The assembly ring as claimed in claim 1, wherein the functional ring has a holding collar and a sealing portion.

5. The assembly ring as claimed in claim 1, wherein the functional ring has a support portion.

6. The assembly ring as claimed in claim 1, wherein the supporting ring has at least one clamping element.

7. The assembly ring as claimed in claim 6, wherein the supporting ring has at least one first assembly element for fixing to a first pipe.

8. The assembly ring as claimed in claim 7, wherein the supporting ring has at least one second assembly element for fixing to a second pipe.

9. The assembly ring as claimed in claim 8, wherein the at least one holding element, first and second assembly elements and/or clamping elements are each formed in pairs at diametrically opposite positions along the circumference of the supporting ring.

10. The assembly ring as claimed in claim 6, wherein the at least one clamping element simultaneously forms the at least one holding element.

11. The assembly ring as claimed in claim 1, wherein the functional ring is a sealing element.

12. The assembly ring as claimed in claim 1, wherein the functional ring has at least one, radially inwardly projecting, elastically deformable fingers.

13. A pipe connection system for connecting a first pipe and a second pipe, wherein the pipe connection system comprises a V-profile clamp and an assembly ring as claimed in claim 1, wherein the first pipe has a funnel-shaped end and the second pipe has a biconical end, and wherein the functional ring of the assembly ring in the mounted state is arranged between the inside of the funnel-shaped end of the first pipe and the outside of the biconical end of the second pipe, and wherein the supporting ring of the assembly ring in the mounted state is arranged between the first pipe, the second pipe and the V-profile clamp.

14. The pipe connection system as claimed in claim 13, wherein a pre-positioning device is formed between at least one pipe and the supporting ring of the assembly ring, wherein the pre-positioning device has a pin element formed on the supporting ring and a groove formed on the first pipe or on the second pipe.

15. The pipe connection system as claimed in claim 14, wherein the supporting ring has at least one clamping element and has at least one first assembly element for fixing to the first pipe and has at least one second assembly element for fixing to the second pipe, the pin element of the pre-positioning device is formed by the at least one holding element the at least one first or second assembly element or the at least one clamping element of the supporting ring or as part of the at least one holding element as part of the at least one first or second assembly element or as part of the at least one clamping element of the supporting ring.
